(19) United States
(12) Patent Application Publication
(10) Pub. No.: US 2005/0265699 A1
(43) Pub. Date: Dec. 1, 2005

(54) Information recording device and information recording method

(75) Inventors: Shunichi Chiba, Ome-shi (JP); Noriya Sakamoto, Ome-shi (JP); Masahiro Yamada, Nishitama-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/138,883

(22) Filed: May 27, 2005

(30) Foreign Application Priority Data
May 31, 2004 (JP) 2004-161426

(51) Int. Cl. H04N 5/76; H04N 5/781

(52) U.S. Cl. 386/98; 386/96

(57) ABSTRACT

A demultiplexer unit separates a transport stream (TS) of an input digital broadcast into video information and audio information. A video decoder decodes the video information output from the demultiplexer unit to output a video signal. An encoder encodes the video signal output from the video decoder. A buffer stores the audio information output from the demultiplexer unit. A remultiplexing unit multiplexes video information encoded by the encoder and the audio information stored in the buffer. An HDD stores the video and audio information multiplexed in the remultiplexing unit.

### CROSS-REFERENCE TO RELATED APPLICATIONS

This application is based upon and claims the benefit of priority from prior Japanese Patent Application No. 2004-161426, filed May 31, 2004, the entire contents of which are incorporated herein by reference.

### BACKGROUND OF THE INVENTION

1. Field of the Invention

The present invention relates to an information recording device adapted to reencode the transport stream (TS) in a received digital broadcast and record the reencoded TS on a recording medium.

2. Description of the Related Art

In digital broadcasting, MPEG-2 encoded video information and MPEG-2 encoded audio information are packetized and multiplexed with other data for transmission by the MPEG-2 system. The MPEG-2 system is a standard for transmitting MPEG-2 encoded data in multiplexed form and is defined in ISO/IEC 13818-1.

Coded video and audio information is referred to as an elementary stream (ES), which is packetized in significant units: frame units for video and block units for audio. A packetized version of the ES is called a packetized elementary stream (PES). The PES contains time information. Video and audio can be synchronized using the time information. A multiplex signal form in which PESs are simply arranged with a header is called a program stream (PS). The PS is used in transmitting or storing only one program in an error-free environment, such as a DVD.

In the case of transmission such as broadcasting, transmission paths contain errors. Therefore, coded video and audio are multiplexed in a multiplex signal form called a transport stream (TS). The TS is composed of successive TS packets. Each TS packet is obtained by dividing a PES and has a length of 188 bytes including a 32-bit header. Each TS packet contains 13-bit information called a packet identifier (PID). The PID indicates what the corresponding TS packet transmits. The video TS and the audio TS have different PIDs, allowing the TS receiving end to restore received TS to the original PES using PIDs.

A method for recording a digital broadcast is to record the TS in the digital broadcast as it is, which allows recording with the same quality as that of the broadcast. In this case, however, the amount of data required for recording depends on the stream rate of the broadcast and is large. In order to record a long-duration program or many programs, a large-capacity recording medium is required. Therefore, the price of the recording equipment cannot be kept down.

A method for recording a long-duration digital broadcast on a recording medium of limited recording capacity is one which involves decoding the TS in the digital broadcast, then reencoding the TS using an MPEG encoder and recording the resulting reencoded stream (Japanese Unexamined Patent Publication No. 2002-118825). In this case, the rate of the recorded stream can be controlled by the setting rate in the MPEG encoder. For lengthy recording, encoding at a lower rate will require a smaller recording capacity.

When a stream obtained by reencoding the TS in a digital broadcast is recorded as described above, the quality of recorded video or audio will become poorer than that of the broadcast.

Recent DVD recorders allow a broadcast which is being reservation-recorded to be reproduced and viewed from the beginning. In order to reproduce a broadcast program while it is being recorded, two decoders are required for each of the video and audio, increasing the cost of the recording device.

### BRIEF SUMMARY OF THE INVENTION

In the present invention, to allow long-duration recording of a digital broadcast, the digital broadcast is reencoded and video and audio signals are remultiplexed and then recorded. In this case, only the video signal is reencoded and the audio signal is recorded asreceived (asbroadcast).

To remultiplex the reencoded video and the original (as-received) audio, it is necessary to rewrite the PTS of the original audio TS packets. At this time, the difference in STC between a video encoder and a video decoder is used as the difference between the original PTS and the new PTS. In addition, to remultiplex the reencoded video and the original audio, buffer control is used.

The present invention allows the TS of a digital broadcast to be recorded with the amount of data of the TS reduced without using an audio decoder and degrading the quality of audio information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the relationship between TS, PES and ES in the case of video data;

FIG. 2 shows the structure of the TS header;

FIG. 3 is a schematic representation of one embodiment of signal processing according to the present invention;

FIG. 4 is a schematic block diagram of a recording device according to an embodiment of the present invention;

FIG. 5 is a diagram for use in explanation of a process of decoding MPEG encoded audio information and then reencoding the decoded audio information at the same encode setting rate;

FIG. 6 shows the amount of stored data in the buffer during recording;

FIG. 7 shows the arrangement for carrying out processing prior to the start of recording;

FIG. 8 shows the structure of a PAT;

FIG. 9 shows the structure of a PMT;

FIG. 10 is a flowchart illustrating the operation of the demultiplexer unit;

FIG. 11 is a flowchart illustrating the operation of the remultiplexer unit; and

FIG. 12 is a schematic block diagram of a recording device according to a second embodiment of the present invention.

### DETAILED DESCRIPTION OF THE INVENTION

The embodiments of the present invention will be described in detail below with reference to the accompanying drawings.

Before describing a recording device, a TS, PES and ES will be described.

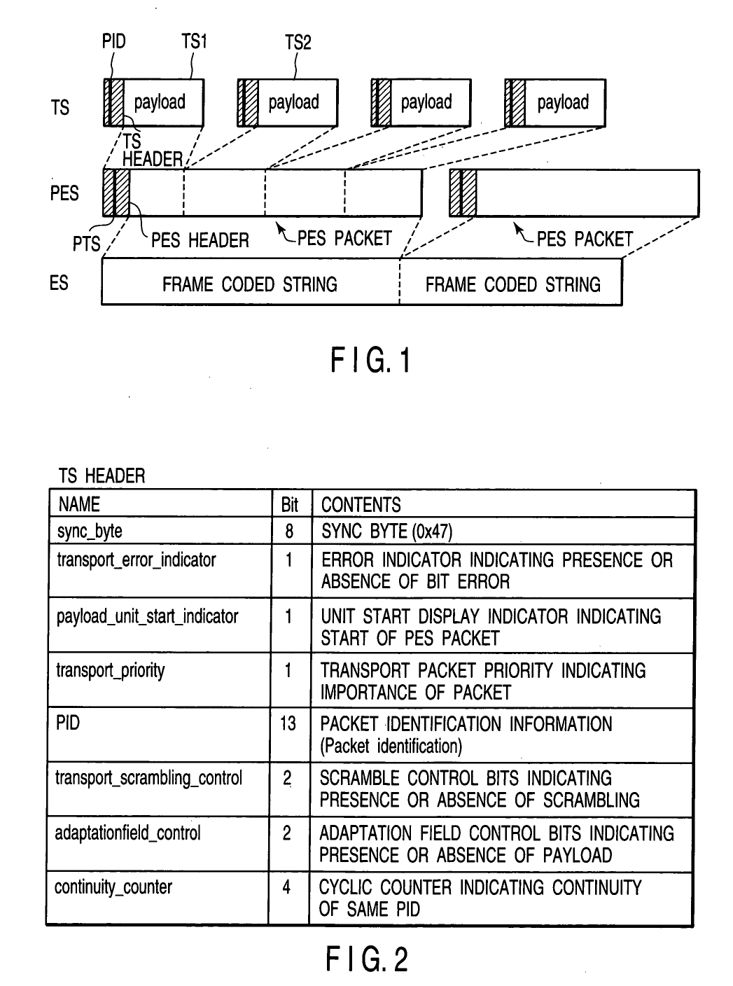

FIG. 1 shows a relationship between the TS, PES and ES in the case of video data and FIG. 2 shows the structure of the TS header.

The elementary stream (ES) is a code string obtained by encoding video information in frame units with compression. The packetized elementary stream (PES) is one obtained by dividing each frame of the ES into packets and appending a PES header to the top of the packets. The MPEG-2 standards do not specify any division unit for transforming the ES into a PES. Assuming that the TS is broadcast with data inserted in it, the ES is divided in frame units according to broadcasting standards and transformed into the PES. The PES header contains a presentation time stamp (PTS) which is time information for outputting the corresponding frame and a decoding time stamp (DTS) which is time information for decoding the corresponding frame. A packet in which a PES header is appended to one frame of ES is referred to as a PES packet.

The TS is composed of TS packets each of a fixed length of 188 bytes and used in real-time transmission and communication systems including digital broadcasting. Each TS packet has a header having a fixed length of four bytes and the remaining portion of 184 bytes is composed of a variable-length adaptation field and a payload. Each payload stores a division of a PES packet.

As shown in FIG. 2, the TS header contains a packet ID (PID), allowing identification of whether data in the TS packet is audio or video. All the video packets transmitted in TS have the same PID attached. To obtain video data from TS, therefore, TS packets having video PID are simply extracted. A video PES is obtained by concatenating only payloads in the extracted TS packets. The process of specifying a TS packet PID and extracting (separating) desired TS packets is called herein demultiplexing.

One PES packet is divided into payloads of TS packets having the same PID. Thus, one TS packet will never contain information from two or more PES packets. When a certain program is composed of a video coded stream and an audio coded stream, both the streams are multiplexed with a TS packet having a unique PID as a unit. In addition to such media multiplexing, the TS has a function of multiplexing two or more programs.

In order to indicate what information packets of the same PID actually possess, identification information is required. To describe a relationship between PIDs and TS contents, the TS is transmitted with table information, called program specific information (PSI), stored in payloads. The PSI contains a program map table (PMI) indicating the PIDs of two or more streams constituting a program, a program association table (PAT) indicating the correspondence between the program number and the PMT, and a conditional access table (CAT) indication limited receiving information. The PMI can contain explanatory information for programs or streams constituting the program in units of finer sections or descriptors. In digital broadcasting, use can be made of a table, such as a network information table (NIT), to perform the function of an electronic program guide (EPG) or receive TS on a desired channel.

Information caused to contain program information by expanding PSI information is service information (SI). Program names and a program guide (EPG) are transmitted via the SI. In many cases, the SI is regarded as part of the PSI and hence handled collectively as PSI/SI information. In addition, since the SI contains almost all of the EPG, it is often handled collectively as SI/EPG.

Next, the TS recording method of the recording device of the present invention will be described.

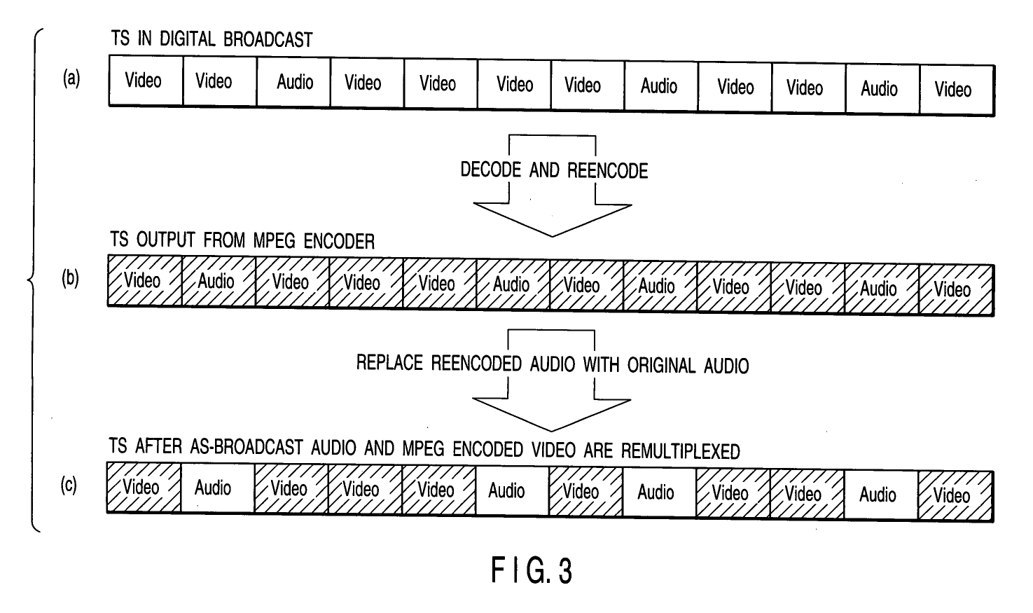

FIG. 3 is a schematic representation of one embodiment of signal processing according to the present invention. In recording video and audio on a recording medium, the present invention reencodes only the video, and does not reencode the audio. In the description which follows, unless otherwise stated, the video indicates video packets or video data and the audio indicates audio packets or audio data.

The TS transmitted from a broadcasting station as shown in FIG. 3(a) is separated, decoded, and reencoded to reduce the amount of data according to data types as shown in FIG. 3(b). As shown in FIG. 3(c), the reencoded video and the as-received audio (not reencoded) are remultiplexed and then recorded on a recording medium such as a hard disk. In FIG. 3, each video/audio block is a TS packet of 188 bytes. The hatched TS packets are reencoded packets and the white TS packets are as-received (as-broadcast) packets.

In general, the rate of audio is very low in comparison with the rate of video. Thus, reencoding (compression) of only video allows long recording of a digital broadcast at a low rate. With reencoding of video only, the quality of audio can be maintained at the same level as that of the broadcast, eliminating the need of a relatively expensive audio encoder for Dolby AC-3 or 5.1-ch surround.

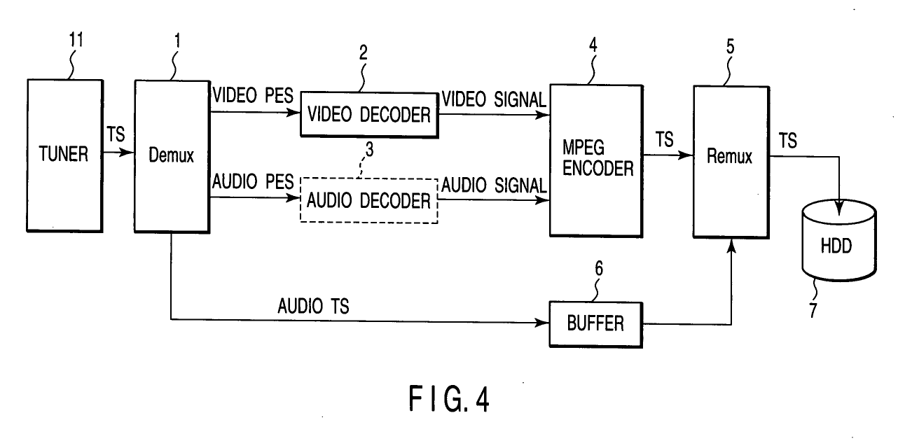

FIG. 4 is a schematic block diagram of a recording device according to an embodiment of the present invention.

The TS selected by a tuner 11 is input to a demultiplexer unit (hereinafter referred to as a demux unit) 1. The demux unit 1 separates the input TS of a digital broadcast into video and audio. The separated video and audio are sent to a video decoder and an audio decoder, respectively, with conversion into the PES form shown in FIG. 1. The audio is temporarily stored in a buffer 6 as it is in the TS form.

The video decoder 2 and the audio decoder 3 decode the video PES and the audio PES, respectively. The resulting video and audio signals are sent to an MPEG encoder 4. Although the audio decoder 3 is provided herein for convenience of illustration, it may be omitted. Alternatively, the audio may be applied to the MPEG encoder 4 as silent data (null packets).

The MPEG encoder 4 MPEG-TS encodes the input video and audio signals, The TS packets (having MPEG compressed data) obtained through encoding are then sent to a remultiplexer unit (hereinafter referred to as a remux unit) 5.

The remux unit 5 replaces the input audio TS packets from the MPEG encoder 4 with the audio TS packets stored in the buffer 5. Thereby, a TS is obtained in which video information output from the MPEG encoder 4 and as-broadcast audio information have been remultiplexed. The resulting TS is recorded on a recording medium such as a hard disk. To remultiplex audio, the audio rate in the encoder 4 is set higher than the original audio rate.

In remultiplexing the audio TS packets from the buffer 6 in the remux unit 5 of FIG. 4, it is required to rewrite the PTS values described in the audio PES headers (see FIG. 1). The MPEG-encoded audio data has a unit of reproduction called an access unit (one audio frame). For each access unit, a time stamp (PTS) is provided which indicates the timing of reproducing the corresponding access unit in a reference system time clock (STC). When the PTS coincides with the STC in the decoder, the corresponding access unit having that PTS is output from the decoder.

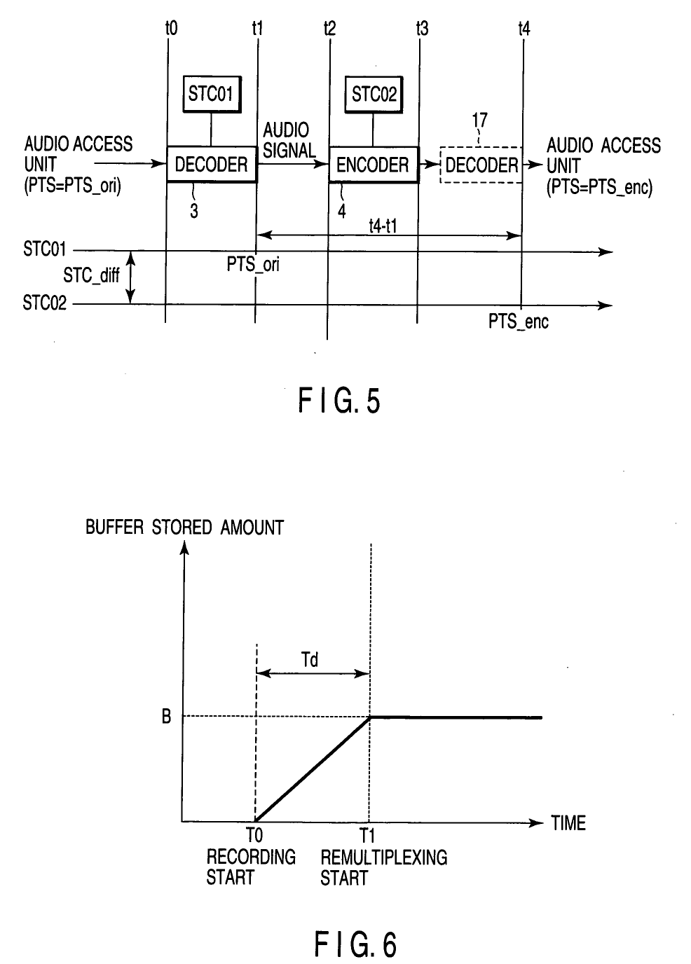

Consider here that MPEG-encoded audio is decoded and then reencoded with the same encode setting (the same data rate). In this case, audio of one access unit is obtained from audio of one access unit. This process is schematically illustrated in FIG. 5.

Suppose that the PTS of an access unit prior to recording (audio PES obtained from TS transmitted from a broadcasting station) is PTS ori and the PTS of the access unit after reencoding is PTS enc. Further, suppose that the time when the access unit is input to the decoder 3 is t0, the time it is output from the decoder 3 is t1, the time it is input to the encoder 4 is t2, and the time it is output from the encoder 4 is t3. Furthermore, suppose that the PTS of the access unit output from the encoder 4 is PTS enc. Then, the time t4 the access unit from the encoder 4 is output from a virtual decoder 17 is PTS enc.

Since the STC of the decoder 3 coincides with PTS ori at time t1, the PTS ori and PTS enc are related by
PTS enc=PTS ori+STC diff+(t4−t1)
where STC diff is the difference in STC between the decoder and the encoder.

Although (t4−t1) varies according to the characteristics of the encoder and the setting rate, it may be considered as constant so long as encoding is performed at the same setting rate. That is, it is possible to examine the value of (T4−t1) in advance through experiment.

When audio temporarily stored in the buffer 6 is remultiplexed in the remux unit 5, the PTS of the temporarily stored audio is rewritten assuming that the audio to be multiplexed has been reencoded through the decoder and the encoder. That is, supposing that the original PTS is PTS old and the difference in STC between the decoder 3 and the encoder 4 is STC diff, the new PTS, PTS new, becomes
PTS new=PTS old+STC diff+Td (1)
Td in equation (1), which corresponds to (t4−t1) in the above equation, is a delay time dependent on the setting rate of the encoder. As Td use is made of a value corresponding to the setting rate of the encoder.

Next, consider the capacity required for the audio buffer 6 in FIG. 4. Assuming that the audio transfer rate is fixed, the rate at which the demux unit 1 writes audio TS packets into the buffer 6 and the rate at which the remux unit 5 reads audio TS packets from the buffer are identical at all times. As shown in FIG. 6, therefore, the amount of stored data in the buffer 6 increases from the time T0 of commencing the storage of audio into the buffer until the time T1 of commencing remultiplexing and then becomes constant. Conversely, the remux unit 5 simply performs remultiplexing so that the amount of buffer becomes constant after time T1.

Consider here the time T1 of commencing the remultiplexing. (T1−T0) is the time during which audio is stored and corresponds to the time required by decoding and encoding, i.e., (t3−t0) in FIG. 5. Since the audio stored in the buffer 6 and remultiplexed can be regarded as audio which has been encoded identically to the original audio, (t4−t3) and (t1−t0) can be regarded as being equal to each other. For this reason, (T1−T0)=(t3−t0)=(t4−t1). Thus, the time T1 of commencing remultiplexing becomes
T1=T0+Td (2)
where Td is identical to that in equation (1).

That is, the capacity B of the buffer used to temporarily store audio must be greater than original audio rate×delay time Td.

Hereinafter, an embodiment of a recording operation of the present invention will be described in detail.

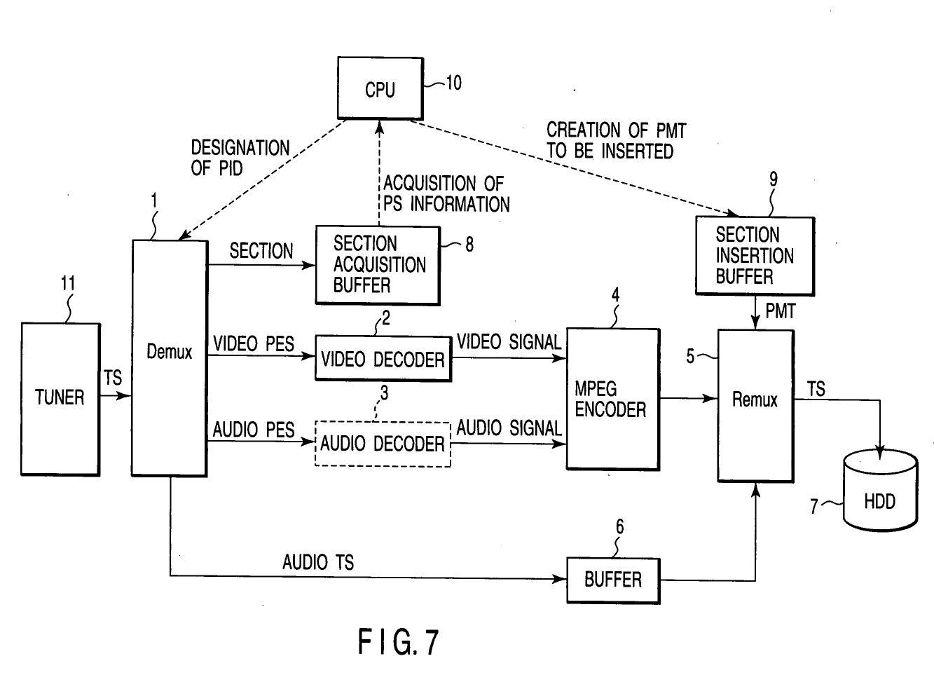

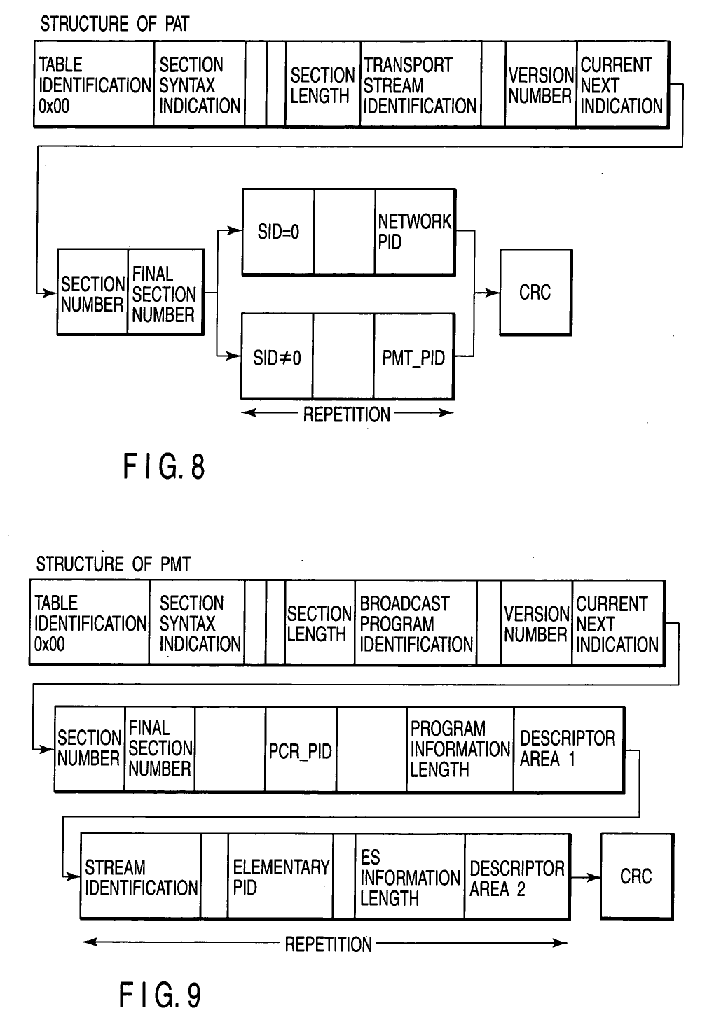

FIG. 7 shows the arrangement for carrying out processing prior to the start of recording. FIG. 8 shows the structure of the PAT. FIG. 9 shows the structure of the PMT.

The PAT stores a list of services carried out in a certain TS in the form of a list of PIDs in a PMT each indicating a service. The PID of the PAT is always fixed at zero. The PMT stores PIDs of images and audio contained in a certain service. If PIDs of images and audio can be obtained from the PMT, original moving images can be reproduced by collecting packets having these PIDs.

In the processing prior to the start of recording, the processes carried out by the main CPU 10 on the demux unit 1 are as follows:
1a. Instruct the demux unit 1 to transfer the section, i.e., PAT, stored in the payload of a TS packet the PID of which is 0×0000 to the section acquisition buffer 8.
1b. Analyze the PAT transferred to the section acquisition buffer 8 and deduce the PID of the PMT.
1c. Set the PID of that PMT in the demux unit 1 and instruct the demux unit to transfer the PMT to the section acquisition buffer 8.
1d. Analyze the PMT transferred from the demux unit 1 to the section acquisition buffer and deduce PID of video, audio and PCR.
1e. Set the PID of video, audio and PCR in the demux unit 1.

Next, the processes carried out by the main CPU to create PMT to be inserted are as follows:
2a. Prepare one in which audio information has been removed from the PMT output from the MPEG encoder 4 as a model of a new PMT. As long as the MPEG encoder 4 is operated at the same setting, the format of TS video and audio and the PID value of each TS packet output from the MPEG encoder do not vary (the encoder can be operated without changing the format and the PID value). That is, the contents of the PMT do not vary. Thus, if a model of a new PMT has been prepared in advance, it does not need to be created with each recording.
2b. Add audio information of the PMT of the digital broadcast program to be recorded (the PMT acquired in 1d) to the new PMT model in 2a.
2c. Rewrite the section length and CRC in the PMT in 2b to correct values.
2d. Develop TS packets storing the PMT in 2c in the section insertion buffer.

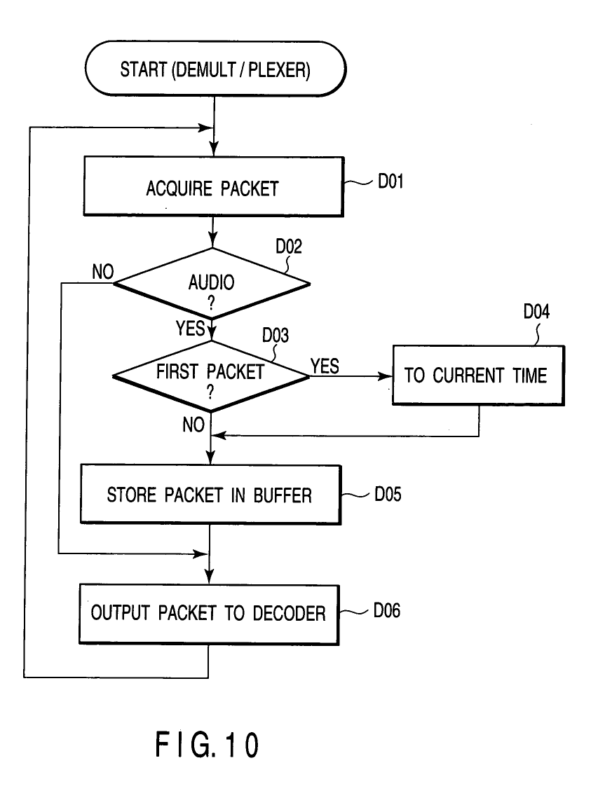

FIG. 10 is a flowchart illustrating the operation of the demux unit 1.

In step D01, a TS packet is obtained from TS in a received digital broadcast.

In step D02, a decision is made on the basis of the PID described in the TS packet header as to whether or not the TS packet is an audio packet.

In steps D03 and D04, the time T0 when the temporary storage of the audio packet was commenced is retained. The time is employed later in the remux unit.

In step D05, the audio packet acquired is stored into the buffer 6.

In step D06, each of the video, audio and section (PAT, PMT) packets is sent to a corresponding processing unit.

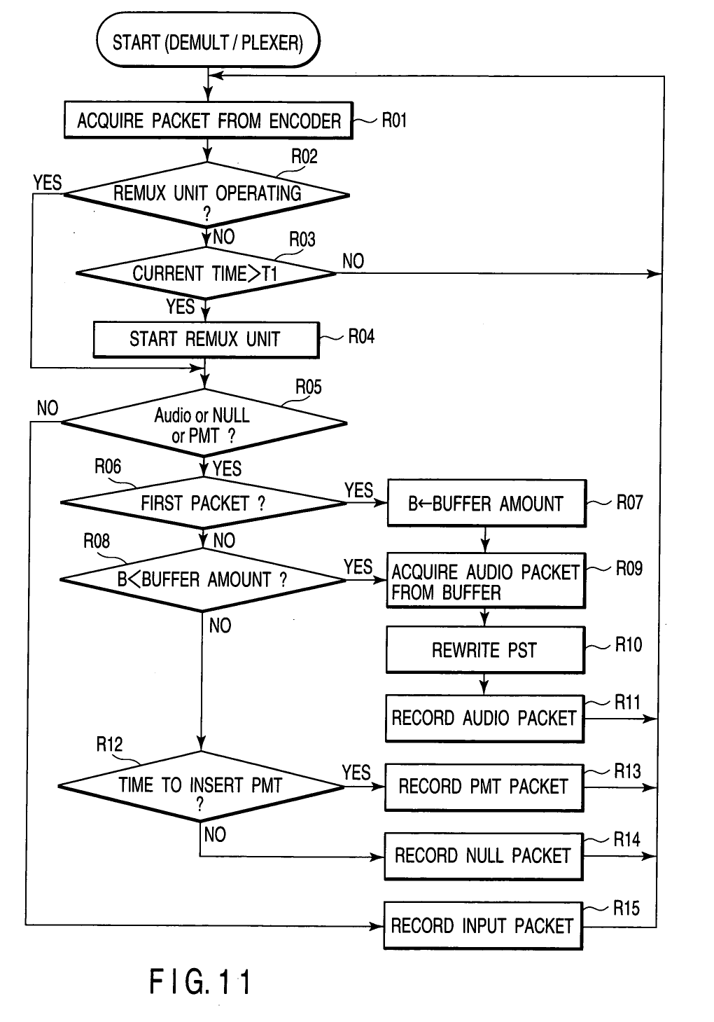

FIG. 11 is a flowchart illustrating the operation of the remux unit 5.

In step R01, a TS packet is acquired from TS received from the encoder 4.

In steps R02 to R94, remultiplexing is started after a delay of Td from the time T0 the temporal storage of audio packet was commenced. Packets acquired prior to the commencement of remultiplexing are discarded.

In step R05, the packet type is judged from the PID described in the header of the TS packet. When the TS packet corresponds to audio, null, or PMT, remultiplexing is performed. To remultiplex audio, it is required to change PMT information. For this reason, no encoder-created PMT is used.

In steps R06 and R07, the amount of data stored in the buffer 6 when remultiplexing of audio was commenced (T1 of FIG. 6) is retained as B.

In step R08, if the amount of stored data in the buffer 6 is larger than B (YES), then audio is remultiplexed in step R09; otherwise, the flow goes to step R12 without remultiplexing audio.

In steps R09 to R11, the audio packet temporarily stored in the buffer 6 is acquired (audio packets acquired from the encoder 4 are discarded), and the audio packet is recorded on the recording medium 7 with the PTS rewritten.

Step R10 will be described in detail here. In step R10, the payload unit start indicator in the header of an audio TS packet obtained from the buffer is checked first. If the value of the payload unit start indicator is 1, a PES header (PTS) is contained in the payload of that TS packet as with the TS packet TS1 of FIG. 1, in which case a PTS rewriting process is performed. That is, the differential value of STC values of the decoder 3 and the encoder 4 is obtained and the PTS value is then rewritten according to equation (1).

If the value of the payload unit start indicator is 0, no PES header (PTS) is contained in the payload of that TS packet as with the TS packet TS2 of FIG. 1, in which case no PTS rewriting process is required. The TS packet is recorded on the recording medium 7 in step R11.

In step R12, a decision is made as to whether or not it is time to insert PMT. The PMT needs to be inserted at intervals of less than 100 ms according to the MPEG standards.

In step R13, the PMT corresponding to the remultiplexed audio TS packet is recorded on the recording medium. Step R13 is subdivided into 3a through 3d:
3a. Obtain a PMT-stored TS packet from the section insertion buffer 9 (see FIG. 7).
3b. Rewrite the continuity counter prepared in the TS header (cyclic counter indicating the continuity of the same PID) with an internal variable (4 bits).
3c. Increment the internal variable.
3d. Record the TS packet having its continuity counter rewritten on the recording medium 7.

In step R14, a null packet is inserted in place of audio and PMT.

In step R15, when the TS packet is not an audio packet, a null packet, or PMT (that is, when the TS packet from the encoder 4 is a video packet in step R05), the video packet is recorded on the recording medium 7 as it is.

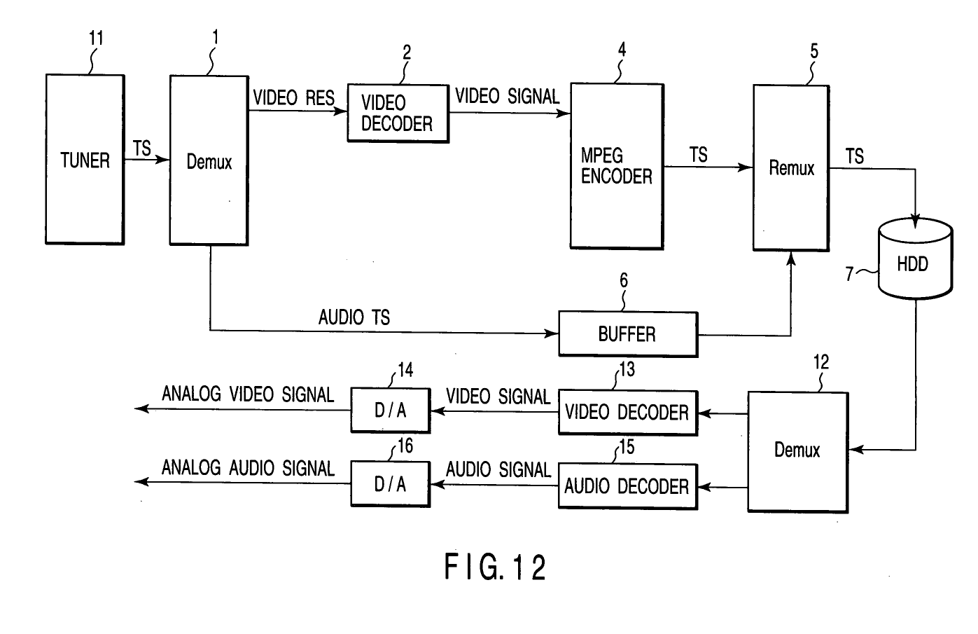

FIG. 12 is a schematic block diagram of a recording device according to a second embodiment of the present invention. In FIG. 12, like reference numerals are used to denote corresponding components to those in FIG. 4 to simplify the description.

The encoder 4 encodes a video signal from the video decoder 2 and then outputs video TS packets and null packets (silence) as audio TS packets. The TS packets from the remux unit 5 are recorded on the recording medium (hard disk) 7.

A demux unit 12 separates video and audio (null packets) read from the HDD 7 and supplies the video packets and the audio packets to a video decoder 13 and an audio decoder 15, respectively. A digital-to-analog converter 14 converts a digital video signal from the video decoder 13 to output an analog video signal. A digital-to-analog converter 16 converts a digital audio signal from the audio decoder 15 to output an analog audio signal.

The second embodiment allows a broadcast program which is under reservation recording by way of example to be reproduced and viewed from the beginning. In such a case, although two audio decoders have been required heretofore, the second embodiment requires only one audio decoder.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information recording device comprising:
a separation unit which separates a transport stream (TS) of an input digital broadcast into video information and audio information;
a video decoder which decodes the video information output from the separation unit to output a video signal;
an encoder which encodes the video signal output from the video decoder;
a buffer which stores the audio information output from the separation unit;
a multiplexing unit which multiplexes video information encoded by the encoder and the audio information stored in the buffer; and
a storage unit which stores the video and audio information multiplexed in the multiplexing unit.

2. The information recording device according to claim 1, wherein the multiplexing unit includes a rewrite section which rewrites a presentation time stamp (PTS) of the audio information stored in the buffer and multiplexes video information encoded in the encoder and audio information which has its PTS rewritten in the rewrite section.

3. The information recording device according to claim 2, wherein the rewrite section determines a new PTS value from the sum of the original PTS value, the difference in system time clock (STC) between the video decoder and the encoder, and a delay time associated with the encoder.

4. An information recording device comprising:
a first separation unit which separates a transport stream (TS) of an input digital broadcast into video information and audio information;
a first video decoder which decodes the video information output from the first separation unit to output a video signal;
an encoder which encodes the video signal output from the first video decoder;
a buffer which stores the audio information output from the first separation unit;
a multiplexing unit which multiplexes video information encoded by the encoder and the audio information stored in the buffer;
a storage unit which stores the video and audio information multiplexed in the multiplexing unit;
a second separation unit which separates the multiplexed video and audio information stored in the storage unit into video information and audio information;
a second video decoder which decodes the video information separated in the second separation unit to output a video signal; and
an audio decoder which decodes the audio information separated in the second separation unit to output an audio signal.

5. The information recording device according to claim 4, wherein the multiplexing unit includes a rewrite section which rewrites a presentation time stamp (PTS) of the audio information stored in the buffer and multiplexes video information encoded in the encoder and audio information which has its PTS rewritten in the rewrite section.

6. An information recording method comprising the steps of:
separating a transport stream (TS) of an input digital broadcast into video information and audio information;
decoding the separated video information to output a video signal;
encoding the video signal;
buffering the separated audio information;
multiplexing the encoded video information and the stored audio information; and
storing the multiplexed video and audio information.
